(19) United States
(12) Patent Application Publication
(10) Pub. No.: US 2016/0165137 A1
(43) Pub. Date: Jun. 9, 2016

(54) IMAGING APPARATUS AND METHOD OF CONTROLLING THE SAME

(71) Applicant: SAMSUNG ELECTRO-MECHANICS CO., LTD., Suwon-si (KR)

(72) Inventor: Soon Seok KANG, Suwon-si (KR)

(73) Assignee: SAMSUNG ELECTRO-MECHANICS CO., LTD., Suwon-si (KR)

(21) Appl. No.: 14/943,308

(22) Filed: Nov. 17, 2015

(30) Foreign Application Priority Data
Dec. 5, 2014 (KR) 10-2014-0174092

(51) Int. Cl. H04N 5/232; G02B 27/64; H04N 5/353

(52) U.S. Cl. CPC H04N 5/23248; H04N 5/23254; H04N 5/3532; G02B 27/646

(57) ABSTRACT

An imaging apparatus and method of controlling the same is disclosed. The imaging apparatus includes camera modules, a motion sensor configured to sense a motion of the imaging apparatus to generate a motion value, a controller configured to generate a control signal to adjust a position of a lens of the camera modules based on the motion value, a image stabilizers configured to adjust the position of the lens of the camera modules in response to the control signal and to sense the adjusted position of the lens, and a selector configured to select at least one of the first image stabilizing unit or the second image stabilizing unit, in response to a selective input signal, to transfer the control signal to the selected image stabilizer, and to transfer the sensed position of the lens to the controller from the selected image stabilizer.

### CROSS-REFERENCE TO RELATED APPLICATION(S)

This application claims the priority and benefit under 35 USC §119(a) of Korean Patent Application No. 10-2014-0174092 filed on Dec. 5, 2014, with the Korean Intellectual Property Office, the entire disclosure of which is incorporated herein by reference for all purposes.

### BACKGROUND

1. Field

The following description relates to an imaging apparatus and a method of controlling the same.

2. Description of Related Art

Technology of correcting hand-shake in a camera using an optical image stabilization (OIS) mechanism has been researched and developed.

A camera module having an OIS function according to the related art requires a control integrated circuit (IC) for controlling the OIS function and a gyro sensor. Here, since an imaging apparatus including a plurality of camera modules separately requires the control IC for controlling the OIS function and a gyro sensor, respectively, there are problems in that both a size of the imaging apparatus and current consumption thereof may be increased.

In addition, since camera modules having such an OIS function, according to the related art, are manufactured using a variety of different processes, a plurality of processes are required to mount various camera modules in a single imaging apparatus, thus consuming a large amount of time in manufacturing the imaging apparatus.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided of an imaging apparatus capable of correcting shaking of a plurality of camera modules using a single control unit, and a method of controlling the same.

In another general aspect, there is provided an imaging apparatus including a first camera module and a second camera module, the imaging apparatus including a motion sensor configured to sense a motion of the imaging apparatus to generate a motion value, a controller configured to generate a control signal to adjust a position of a lens of the first or second camera module based on the motion value, a first image stabilizer configured to adjust the position of the lens of the first camera module in response to the control signal and to sense the adjusted position of the lens, a second image stabilizer configured to adjust the position of the lens of the second camera module in response to the control signal and to sense the adjusted position of the lens, and a selector configured to select at least one of the first image stabilizer or the second image stabilizer, in response to a selective input signal, to transfer the control signal to the selected image stabilizer, and to transfer the sensed position of the lens to the controller from the selected image stabilizer.

The selector may include a first switch configured to transfer the control signal to the selected image stabilizing unit, and a second switch configured to transfer the sensed position of the lens to the controller from the selected image stabilizer.

The first image stabilizer may include a first lens controller configured to adjust the position of the lens of the first camera module, in response to the control signal, and a first position sensor configured to sense the position of the lens of the first camera module.

The second image stabilizer may include a second lens controller configured to adjust the position of the lens of the second camera module, in response to the control signal, and a second position sensor configured to sense the position of the lens of the second camera module.

The controller may include a proportional-integral-derivative (PID) controller configured to receive the position of the lens from the selected image stabilizing unit to calculate a motion vector of the lens corresponding to the motion value, and a control signal generator configured to generate a control signal to adjust the position of the lens depending on the calculated motion vector of the lens.

The PID controller may be operated when a shutter of the camera module is open.

The motion sensor may be a gyro sensor to sense angular speed of the imaging apparatus.

The first position sensor may include hall sensors to detect the position of the lens.

The second position sensor may include hall sensors to detect the position of the lens.

In another general aspect, there is provided a method of controlling an imaging apparatus including a first camera module and a second camera module, the method including receiving a selective input signal to select at least one of the first camera module or the second camera module, selecting an image stabilizer in response to the selective input signal, detecting a motion of the imaging apparatus, adjusting a position of a lens of the selected camera module in response to the detected motion, and sensing the adjusted position of the lens.

The adjusting of the position of the lens may include calculating a motion vector in response to the detected motion, and adjusting the position of the lens based on the motion vector.

The detecting of the motion, the adjusting of the position, and the sensing of the adjusted position may be each performed a number of times when a shutter of the camera module is open.

In another general aspect, there is provided an imaging apparatus including more than one camera modules, the imaging apparatus including a motion sensor configured to sense a motion of the imaging apparatus to generate a motion value, a controller configured to generate a control signal to adjust a position of a lens of the more than one camera modules based on the motion value, more than one image stabilizers corresponding to each of the more than one camera modules, each of the more than one image stabilizers configured to adjust the position of the lens of the corresponding camera module, in response to the control signal and to sense the adjusted position of the lens, a selector configured to select at least one image stabilizer, in response to a selective input signal, to transfer the control signal to the selected image stabilizer, and to transfer the sensed position of the lens to the controller from the selected image stabilizer.

The motion value may correspond to an amount of motion in an opposite direction of the motion of the imaging apparatus.

The controller and the selector may be formed in a single integrated circuit.

The motion sensor, the controller, and the selector may be formed on a single flexible printed circuit.

Other features and aspects will be apparent from the following detailed description, the drawings, and the claims.

### BRIEF DESCRIPTION OF DRAWINGS

FIG. 1 is a diagram illustrating an example of an imaging apparatus.

FIG. 2 is a diagram illustrating an example of first and second image stabilizing units and a selecting unit illustrated in FIG. 1.

FIG. 3 is a diagram illustrating an example of a control unit illustrated in FIG. 1.

FIG. 4 is a diagram illustrating an example of a method of controlling an imaging apparatus.

FIG. 5 is a diagram illustrating an example of an operation of adjusting a position of a lens of FIG. 4.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations is described as an example; the sequence of operations is not limited to that set forth herein and may be changed as is known in the art, with the exception of steps and/or operations that necessarily occur in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

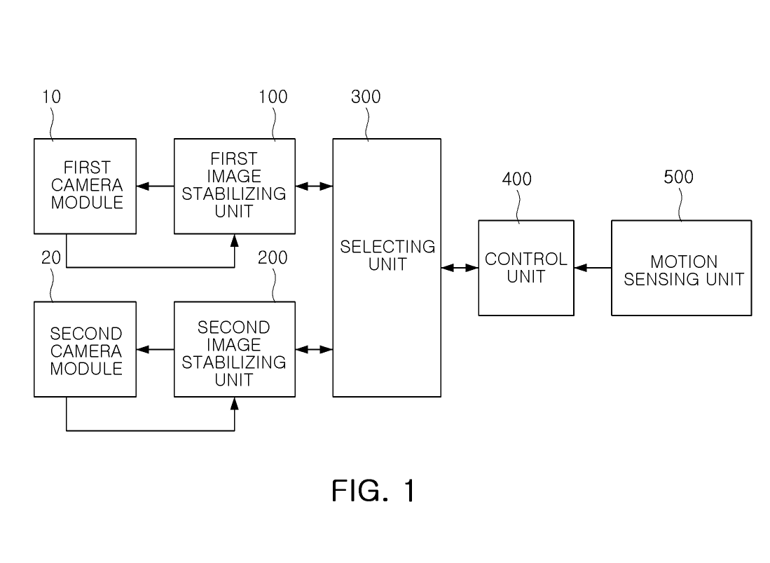

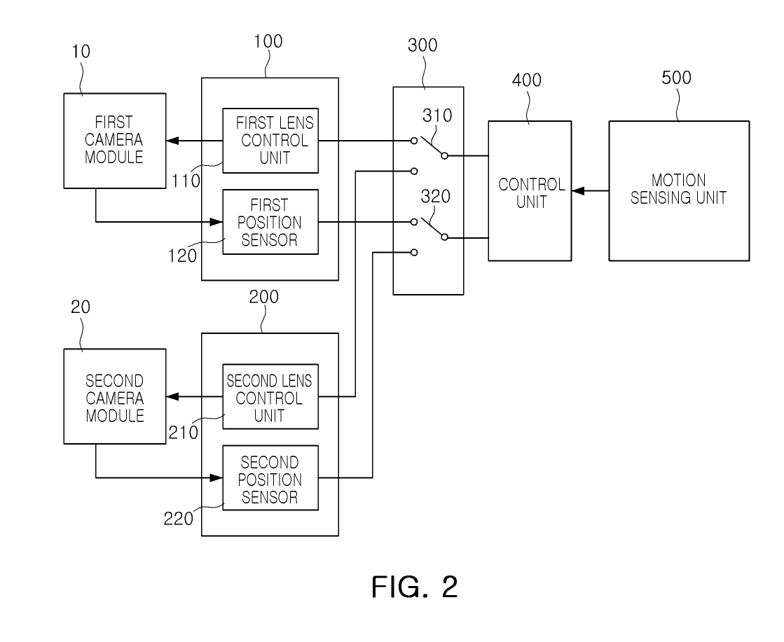

FIG. 1 is a diagram illustrating an example of an imaging apparatus and FIG. 2 is a diagram illustrating an example of first and second image stabilizing units and a selecting unit illustrated in FIG. 1. In the examples shown in FIGS. 1-2, two camera modules and two image stabilizing units are shown. The number of camera modules and image stabilizing units may be varied without departing from the spirit and scope of the illustrative examples described.

Referring to FIGS. 1 and 2, an imaging apparatus including a first camera module 10, a second camera module 20, a first image stabilizing unit 100, a second image stabilizing unit 200, a selecting unit 300, a control unit 400, and a motion sensing unit 500.

The first image stabilizing unit 100 may adjust a position of a lens of the first camera module 10 in response to a control signal received from the control unit 400. In addition, the first image stabilizing unit 100 may sense the position of the first camera module 10 and may output the sensed position to the control unit 400.

The second image stabilizing unit 200 may adjust a position of a lens of the second camera module 20 in response to the control signal received from the control unit 400. In addition, the second image stabilizing unit 200 may sense the position of the second camera module 20 and may output the sensed position to the control unit 400.

The first image stabilizing unit 100 may include a first lens control unit 110 adjusting the position of the lens of the first camera module 10 in response to the control signal input from the control unit 400 and a first position sensor 120 that senses the position of the lens of the first camera module 10. Here, the first position sensor 120 may be a sensor, such as, for example, a hall sensor.

The second image stabilizing unit 200 may include a second lens control unit 210 adjusting the position of the lens of the second camera module 20 in response to the control signal input from the control unit 400 and a second position sensor 220 that senses the position of the lens of the second camera module 20. Here, the second position sensor 120 may be a sensor, such as, for example, a hall sensor.

The first lens control unit 110 and the second lens control unit 210 may adjust the position of the lens using a method, such as, for example, a pulse width modulation (PWM) method or a linear method.

The selecting unit 300 may connect the first image stabilizing unit 100 and the control unit 400, or the second image stabilizing unit 200 and the control unit 400, in response to a selective input signal for selecting either of the first camera module 10 and the second camera module 20. In an example, the selective input signal may be input from the outside. The selective input signal may be directly input to the selecting unit 300 from the outside or may be input to the selecting unit 300 through the control unit 400.

In an example where a selective input signal selecting the first camera module 10 is input to the selecting unit 300, the selecting unit 300 may connect the first image stabilizing unit 100 and the control unit 400 to each other. Thus, a control signal generated by the control unit 400 may be transferred to the first image stabilizing unit 100 and the position of the lens of the first camera module 10 sensed by the first image stabilizing unit 100 may be transferred to the control unit 400.

Likewise, in an example where a selective input signal selecting the second camera module 20 is input to the selecting unit 300, the selecting unit 300 may connect the second image stabilizing unit 200 and the control unit 400 to each other to transfer the control signal to the second image stabilizing unit 200 and transfer the position of the lens of the second camera module 20 to the control unit 400.

According to an example, as illustrated in FIG. 2, the selecting unit 300 may include a first switching unit 310 transferring the control signal to the first image stabilizing unit 100 or the second image stabilizing unit 200 and a second switching unit 320 transferring the position of the lens to the control unit 400 from the first image stabilizing unit 100 or the second image stabilizing unit 200.

Specifically, when the selective input signal selecting the first camera module 10 is input to the selecting unit 300, the first switching unit 310 may be connected to the first lens control unit 110 to transfer the control signal from the control unit 400 to the first lens control unit 110. In addition, the second switching unit 320 may be connected to the first position sensor 120 to transfer the position of the lens of the first camera module 10 from the first position sensor 120 to the control unit 400.

Likewise, when the selective input signal selecting the second camera module 20 is input to the selecting unit 300, the first switching unit 310 may be connected to the second lens control unit 210 to transfer the control signal from the control unit 400 to the second lens control unit 210. In addition, the second switching unit 320 may be connected to the second position sensor 220 to transfer the position of the lens of the second camera module 20 from the second position sensor 220 to the control unit 400.

The control unit 400 may generate a control signal for adjusting the position of the lens of the first camera module 10 or the second camera module 20 in response to a motion value generated by the motion sensing unit 500.

According to an example, the control unit 400 may generate a control signal for adjusting the position of the lens of the first camera module 10 or the second camera module 20 in a direction opposite to that of the motion of the imaging apparatus sensed by the motion sensing unit 500.

Specifically, the control unit 400 may calculate a motion vector corresponding to the motion value generated by the motion sensing unit 500 and may adjust the position of the lens of the first camera module 10 or the second camera module 20 depending on the calculated motion vector.

In an example, the motion value may be an angular speed value and the motion vector may be calculated by integrating the angular speed value. In an example, the control unit 400 may only be operated during a time in which a shutter (not illustrated) of the imaging apparatus is opened.

Here, the control unit 400 may output a prestored bias signal to the position sensor 120 or 220 of the image stabilizing unit 100 or 200 connected to the control unit 400 by the selecting unit 300.

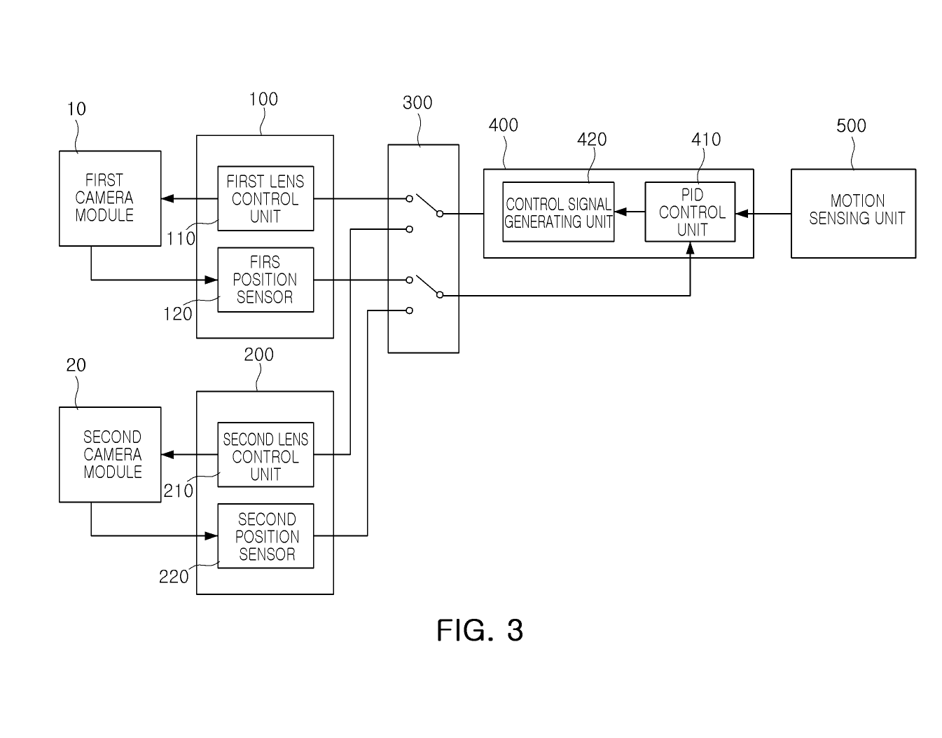

Detailed configurations of the control unit 400 described above will be described with reference to FIG. 3.

The motion sensing unit 500 may sense a motion of the imaging apparatus and may generate a motion value corresponding to the motion. The motion sensing unit 500 may be a sensor, such as, for example, a gyro sensor sensing angular speed of the imaging apparatus.

An angular speed value may include a pitch value or a yaw value. The motion sensing unit 500 may sense the pitch value and the yaw value of the imaging apparatus, and may output the sensed value to the control unit 400.

According to an example, the first camera module 10 may be disposed on a front surface of the imaging apparatus and the second camera module 20 may be disposed on a rear surface of the imaging apparatus. The selecting unit 300 and the control unit 400 may be formed in a single integrated circuit. In an example, the first camera module 10, the second camera module 20, the first image stabilizing unit 100, the second image stabilizing unit 200, the selecting unit 300, the control unit 400, and the motion sensing unit 500 may be formed on a single flexible printed circuit.

FIG. 3 is a diagram illustrating an example of a control unit illustrated in FIG. 1. Referring to FIG. 3, the control unit 400 may include a proportional integral derivative (PID) control unit 410 and a control signal generating unit 420.

The PID control unit 410 may calculate the motion vector corresponding to the motion value of the imaging apparatus, which is sensed by the motion sensing unit 500. The PID control unit 410 may generate the motion vector that includes values corresponding to an amount of motion in an opposite direction of the motion of the imaging apparatus, in order to prevent a motion blur occurring due to the shaking of the imaging apparatus.

The PID control unit 410 may receive a feedback of the position of the lens of the first camera module 10 or the second camera module 20 from the first position sensor 120 or the second position sensor 220 to calculate the motion vector.

The control signal generating unit 420 may generate a control signal to adjust the position of the lens of the first camera module 10 or the second camera module 20 in response to the motion vector calculated by the PID control unit 410. The control signal generating unit 420 may output the generated control signal to the first switching unit 310 of the selecting unit 300.

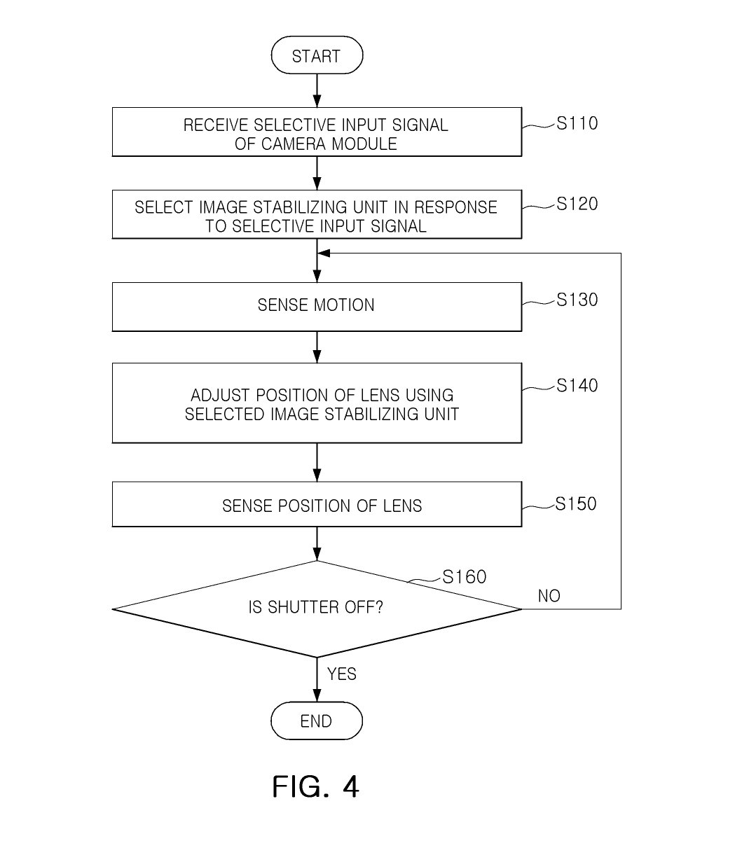

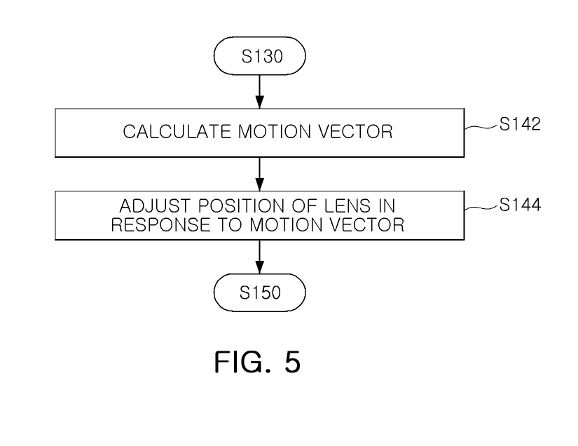

FIG. 4 is a diagram illustrating an example of a method of controlling an imaging apparatus and FIG. 5 is a diagram illustrating an example of an operation of adjusting a position of a lens of FIG. 4. The operations in FIGS. 4-5 may be performed in the sequence and manner as shown, although the order of some operations may be changed or some of the operations omitted without departing from the spirit and scope of the illustrative examples described. Many of the operations shown in FIGS. 4-5 may be performed in parallel or concurrently.

Since an example of a method of controlling an imaging apparatus illustrated in FIG. 4 is performed by the imaging apparatus described above with reference to FIGS. 1 through 3, the above description of FIGS. 1-3 is incorporated herein by reference. Thus, the above description may not be repeated here.

Referring to FIG. 4, in the method of controlling the imaging apparatus according to the embodiment in the present disclosure, in S110, the selective input signal selecting either of the first camera module 10 and the second camera module 20 may be received.

In S120, a selecting unit 300 may select an image stabilizing unit in response to the selective input signal. The selecting unit 300 may connect the first switching unit 310 to the lens control unit 110 or 120 of the selected image stabilizing unit 100 or 200, respectively, so that the control signal output from the control unit 400 may be transferred to the lens control unit 110 or 120. The selecting unit 300 may connect the second switching unit 320 to the position sensor 120 or 220 of the selected image stabilizing unit 100 or 200, respectively, in order to provide feedback regarding a position value of the lens from the position sensor 120 or 220 of the selected image stabilizing unit 100 or 200, respectively, to the control unit 400.

In S130, the motion sensing unit 500 may sense the motion of the imaging apparatus. The sensed motion may be angular speed and the sensed angular value may include a pitch value or a yaw value.

In S140, the control unit 400 may adjust the position of the lens of the camera module 10 or 20 selected by the selective input signal using the image stabilizing unit 100 or 200 connected thereto by the selecting unit 300.

The operation of adjusting the position of the lens in S140 is illustrated in FIG. 5. Since an example of a method of adjusting the position of the lens illustrated in FIG. 5 is performed by the imaging apparatus described above with reference to FIGS. 1 through 3, the above description of FIGS. 1-4 is incorporated herein by reference. Thus, the above description may not be repeated here. In S142, the control unit 400 may calculate the motion vector using the motion value sensed by the motion sensing unit 500 and may generate the control signal adjusting the position of the lens based on the motion vector. The control signal may be output to the lens control unit 110 or 210 of the image stabilizing unit 100 or 200, respectively, connected to the control unit 400 by the first switch 310 of the selecting unit 300. In S144, the lens control unit 110 or 210 receiving the control signal may adjust the position of the lens depending on the control signal.

In S150, the position sensor 120 or 220 of the selected image stabilizing unit 100 or 200, respectively, may sense the position of the lens of the camera module 10 or 20. The sensed position of the lens may be fed-backed to the control unit 400 through the selecting unit 300. According to an example, the control unit 400 may generate the motion vector using the feedback position of the lens and the motion value.

According to an example, the operation of sensing the motion S130 to the operation of sensing the position of the lens S150 may be repeatedly performed a number of times during a time in which a shutter of the imaging apparatus is open.

As set forth above, the imaging apparatus includes the selecting unit connecting the control unit and the first image stabilizing unit to each other or the control unit and the second image stabilizing unit to each other, in response to the selective input signal selecting either of the first camera module and the second camera module. Since the shaking of the plurality of camera modules may be corrected using the single control unit, the imaging apparatus may be miniaturized, a manufacturing time taken in manufacturing the imaging apparatus may be reduced, and costs of manufacturing the imaging apparatus may be decreased.

The apparatuses, units, modules, devices, and other components illustrated that perform the operations described herein are implemented by hardware components. Examples of hardware components include controllers, sensors, generators, drivers and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array (FPGA), a programmable logic array, a microprocessor, an application-specific integrated circuit (ASIC), or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 4-5 that perform the operations described herein are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An imaging apparatus including a first camera module and a second camera module, the imaging apparatus comprising:
a motion sensor configured to sense a motion of the imaging apparatus to generate a motion value;
a controller configured to generate a control signal to adjust a position of a lens of the first or second camera module based on the motion value;
a first image stabilizer configured to adjust the position of the lens of the first camera module in response to the control signal and to sense the adjusted position of the lens;
a second image stabilizer configured to adjust the position of the lens of the second camera module in response to the control signal and to sense the adjusted position of the lens; and
a selector configured to:
select at least one of the first image stabilizer or the second image stabilizer, in response to a selective input signal,
to transfer the control signal to the selected image stabilizer, and
to transfer the sensed position of the lens to the controller from the selected image stabilizer.

2. The imaging apparatus of claim 1, wherein the selector comprises:
a first switch configured to transfer the control signal to the selected image stabilizing unit; and
a second switch configured to transfer the sensed position of the lens to the controller from the selected image stabilizer.

3. The imaging apparatus of claim 1, wherein the first image stabilizer comprises:
a first lens controller configured to adjust the position of the lens of the first camera module, in response to the control signal; and
a first position sensor configured to sense the position of the lens of the first camera module.

4. The imaging apparatus of claim 1, wherein the second image stabilizer comprises:
a second lens controller configured to adjust the position of the lens of the second camera module, in response to the control signal; and
a second position sensor configured to sense the position of the lens of the second camera module.

5. The imaging apparatus of claim 1, wherein the controller comprises:
a proportional-integral-derivative (PID) controller configured to receive the position of the lens from the selected image stabilizing unit to calculate a motion vector of the lens corresponding to the motion value; and
a control signal generator configured to generate a control signal to adjust the position of the lens depending on the calculated motion vector of the lens.

6. The imaging apparatus of claim 5, wherein the PID controller is operated when a shutter of the camera module is open.

7. The imaging apparatus of claim 1, wherein the motion sensor is a gyro sensor to sense angular speed of the imaging apparatus.

8. The imaging apparatus of claim 3, wherein the first position sensor comprises hall sensors to detect the position of the lens.

9. The imaging apparatus of claim 4, wherein the second position sensor comprises hall sensors to detect the position of the lens.

10. A method of controlling an imaging apparatus including a first camera module and a second camera module, the method comprising:
receiving a selective input signal to select at least one of the first camera module or the second camera module;
selecting an image stabilizer in response to the selective input signal;
detecting a motion of the imaging apparatus;
adjusting a position of a lens of the selected camera module in response to the detected motion; and
sensing the adjusted position of the lens.

11. The method of claim 10, wherein the adjusting of the position of the lens comprises:
calculating a motion vector in response to the detected motion; and
adjusting the position of the lens based on the motion vector.

12. The method of claim 10, wherein the detecting of the motion, the adjusting of the position, and the sensing of the adjusted position are each performed a number of times when a shutter of the camera module is open.

13. An imaging apparatus including more than one camera modules, the imaging apparatus comprising:
a motion sensor configured to sense a motion of the imaging apparatus to generate a motion value;
a controller configured to generate a control signal to adjust a position of a lens of the more than one camera modules based on the motion value;
more than one image stabilizers corresponding to each of the more than one camera modules, each of the more than one image stabilizers configured to adjust the position of the lens of the corresponding camera module, in response to the control signal and to sense the adjusted position of the lens;
a selector configured to select at least one image stabilizer, in response to a selective input signal, to transfer the control signal to the selected image stabilizer, and to transfer the sensed position of the lens to the controller from the selected image stabilizer.

14. The imaging apparatus of claim 13, wherein the motion value corresponds to an amount of motion in an opposite direction of the motion of the imaging apparatus.

15. The imaging apparatus of claim 13, wherein the controller and the selector is formed in a single integrated circuit.

16. The imaging apparatus of claim 13, wherein the motion sensor, the controller, and the selector is formed on a single flexible printed circuit.
